(19) United States
(12) Patent Application Publication
(10) Pub. No.: US 2007/0198415 A1
(43) Pub. Date: Aug. 23, 2007

(54) Method and apparatus for categorized reception of an audio program

(76) Inventor: Humberto Herrera, Colton, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 11/357,346

(22) Filed: Feb. 17, 2006

(51) Int. Cl. H04L 9/00

(52) U.S. Cl. 705/51

(57) ABSTRACT

A method and associated apparatus for receiving an audio track by first receiving a program authorization category and a category indicator for an audio track. A received audio track is presented when the audio track category indicator is substantially equivalent to the received program authorization category.

### BACKGROUND

It is truly a wonderful thing that we live in a society that values free speech. Free speech ensures that each and every one of us is entitled to express their own view with respect to any subject whatsoever. The same right of free speech that is so valued by Americans often confounds us as well. For example, the right of free speech provides for the distribution and sale of pornographic material. The right of free speech is also relied upon by artists, playwrights, screenwriters, singers and songwriters.

Today, many popular artistic works are of dubious nature and their value to society is highly questionable. This is especially true in the realm of popular music. Not only is popular music filled with profanity, popular music often incites violent action. Some popular music goes as far as to advocate suicide and gang-rape. The most troubling aspect of such a content or is that it is often targeted at young audiences. Teenagers and adolescents have enough trouble simply trying to understand the physical and emotional changes they undergo as they mature. Popular music that includes profanity and advocates violence can lead to disastrous results when young people can not cope with their personal realities and turn to popular music for inspiration and social guidance.

### BRIEF DESCRIPTION OF THE DRAWINGS

Several alternative embodiments will hereinafter be described in conjunction with the appended drawings and figures, wherein like numerals denote like elements, and in which:

FIGS. 1 and 2 collectively form a flow diagram that depicts one example method for presenting an audio program;

FIG. 3 is a flow diagram that depicts one alternative example method for receiving a program authorization category;

FIG. 4 is a flow diagram that depicts one alternative method for receiving a program authorization category for a particular target user;

FIG. 5 is a flow diagram that depicts one illustrative method wherein a program authorization category is received in the form of a station identifier;

FIG. 5A is a flow diagram that illustrates one example method wherein a program authorization category is received in the form of a maximum volume level for a particular user;

FIG. 6 is a flow diagram that depicts alternative example methods for receiving a category indicator for an audio track;

FIG. 7 is a flow diagram that depicts one example method for receiving a category indicator for an audio track;

FIG. 8 is a flow diagram that depicts alternative example methods for receiving an analog rendition of an audio track;

FIG. 9 is a flow diagram that depicts an alternative example method wherein an audio track is received as a digital datastream;

FIG. 9A is a flow diagram that depicts one example method for receiving an audio track according to user station authorizations;

FIG. 10 is a flow diagram that depicts one example method for presenting an audio track according to a particular user's maximum volume authorization;

FIG. 11 is a block diagram that depicts several example embodiments of an audio presentation system;

FIG. 12 is a pictorial illustration that depicts the internal structure of various alternative embodiments of an authorization unit; and

FIG. 13 is a block diagram that illustrates alternative example embodiments of a demodulator.

### DETAILED DESCRIPTION

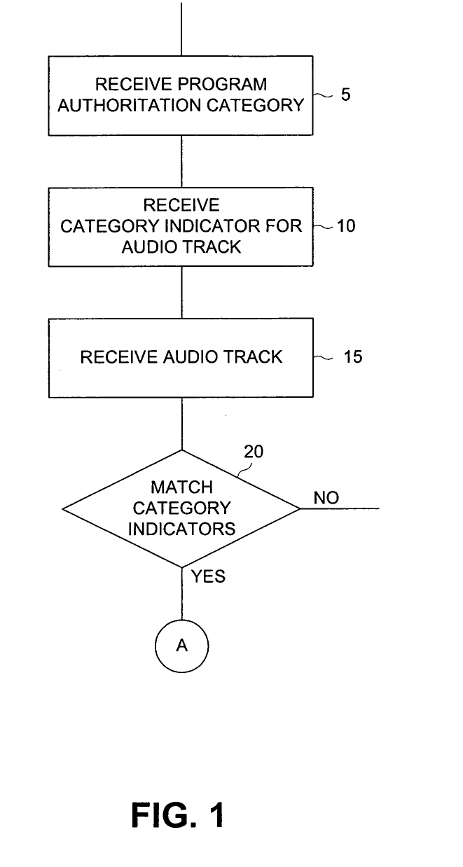

FIGS. 1 and 2 collectively form a flow diagram that depicts one example method for presenting an audio program. According to this example method, an audio program is presented by receiving a program authorization category (step 5). A category indicator is received for an audio track (step 10). It should be appreciated that a category indicator, according to one variation of the present method, comprises a content rating. A content rating, according to alternative variations of the present method, includes ratings such as general audience, parental guidance suggested and restricted. Another illustrative example of a content rating, according to one variation of the present method, includes an indicator that reflects the fact that a particular content includes sexually explicit lyrics. Another indicator, according to yet another illustrative variation of the present method, reflects the fact that a particular content includes profanity. In yet another example variation of the present method, an indicator is used to reflect the fact that a particular content advocates violence (e.g. suicide, murder or rape). According to yet another variation of the present method, a content rating includes a genre indicator (e.g. rock, rhythm-n-blues, heavy-metal, rap). It should be appreciated that a wide variety of indicators can be used as a category indicator for particular audio track and the examples presented herein are intended merely to illustrate various alternative variations of the present method and are not intended to limit the scope of the claims appended hereto. It should also be appreciated that a program authorization category as received in step 5 typically corresponds to a category indicator that is received for an audio track in step 10.

In furtherance of one example method, an audio track is received (step 15). When the category indicator for an audio track matches a program authorization category (step 20), the received audio track is presented to user (step 25). It should further be appreciated that matching the category indicator for an audio track, according to one variation of the present method, is performed by determining a category scale. For example, where content ratings are used, an audio track category indicator that indicates a wider acceptability (e.g. general audience) is typically presentable where a program authorization category of any higher level (e.g. parental guidance or restricted) is received. Accordingly, where a program authorization category of “restricted” is received, an audio track having a category indicator of general audience, parental guidance and restricted will all be presentable according to this variation of the present method. As another example, where a program authorization category of “parental guidance” is received, an audio track categorized as “restricted” will not be presented according to this variation of the present method whereas an idea track categorized as “general audience” or “parental guidance” will be presentable. In yet another variation of the present method, a plurality of program authorization categories are received and a specific match must be made between a category indicator for an audio track and one of the plurality of program authorization categories received according to this variation of the present method.

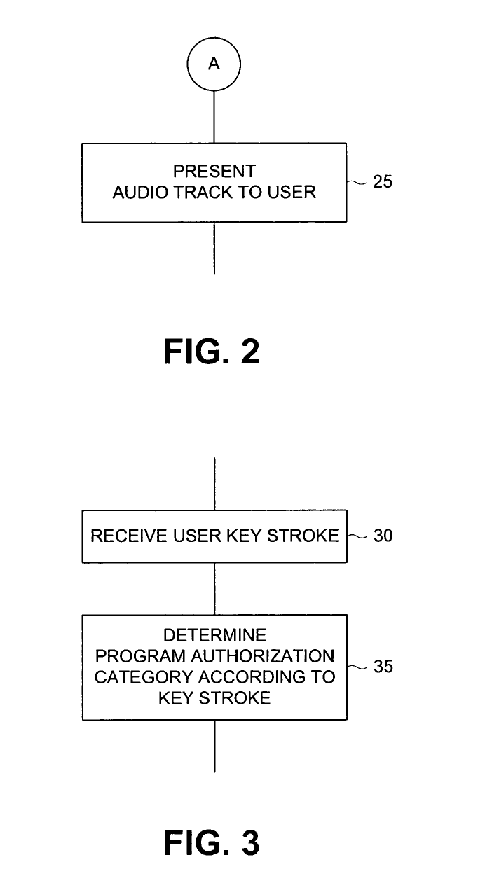

FIG. 3 is a flow diagram that depicts one alternative example method for receiving a program authorization category. According to this variation of the present method, a program authorization category is received by receiving a user keystroke (step 30). It should be appreciated that a user keystroke, according to this variation of the present method, is typically received from some form of user interface device (e.g. a keyboard or a touch-screen device overlaid on a presentation unit). A program authorization category is then determined according to the keystroke (step 35).

FIG. 3A is a flow diagram that depicts one alternative example method for receiving a program authorization category from an authorized user. It should be appreciated that, according to this illustrative variation of the present method, only an authorized user is allowed to specify a program authorization category. Accordingly, a user identifier is received (step 32). A program authorization category is also received from the user (step 37). A program authorization category is established when the user identifier is associated with a user that is authorized to establish a program authorization category (step 39). According to one variation of the present method, a user is authorized to establish a program authorization category by means of a password. In yet another illustrative variation of the present method, a user is authorized implicitly merely by entering a particular user identifier.

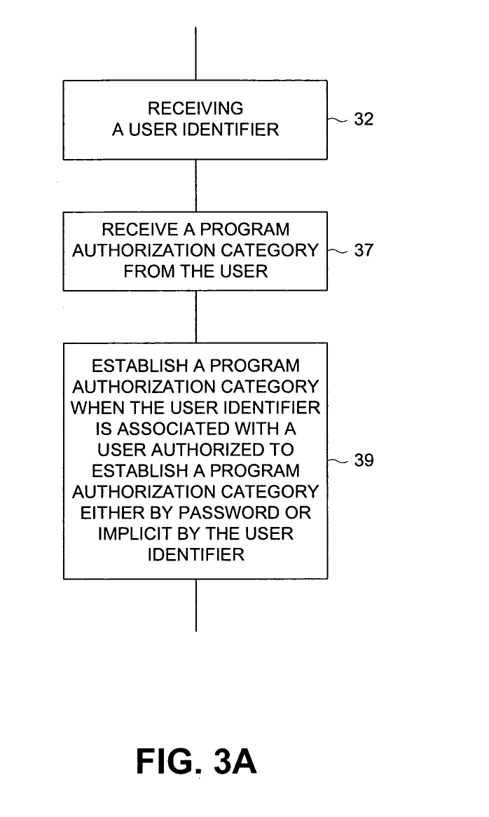

FIG. 4 is a flow diagram that depicts one alternative method for receiving a program authorization category for a particular target user. According to this variation of the present method, a program authorization category is received by first receiving a target user identifier from a user (step 40). The target user identifier is used to identify a particular user for which a program authorization category is to be established. As such, once the program authorization category is received from the user, it is then associated with the target user identifier in order to establish a program authorization category for the target user identifier (step 47). It should be appreciated that the user from which a particular program authorization category is received may need to be an authorized user has heretofore described.

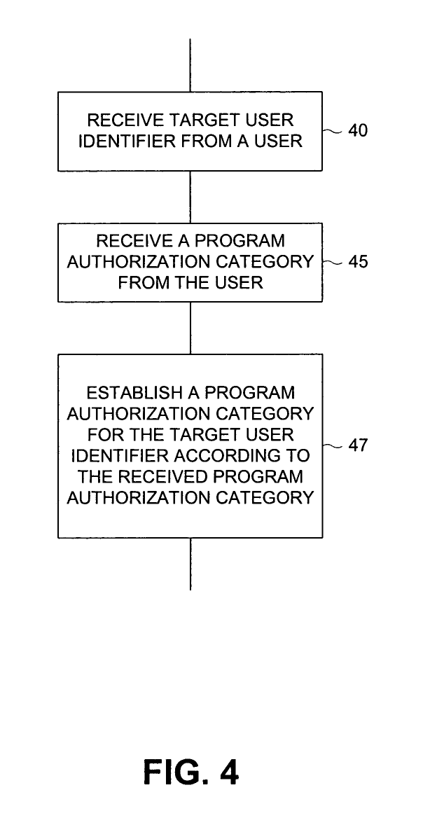

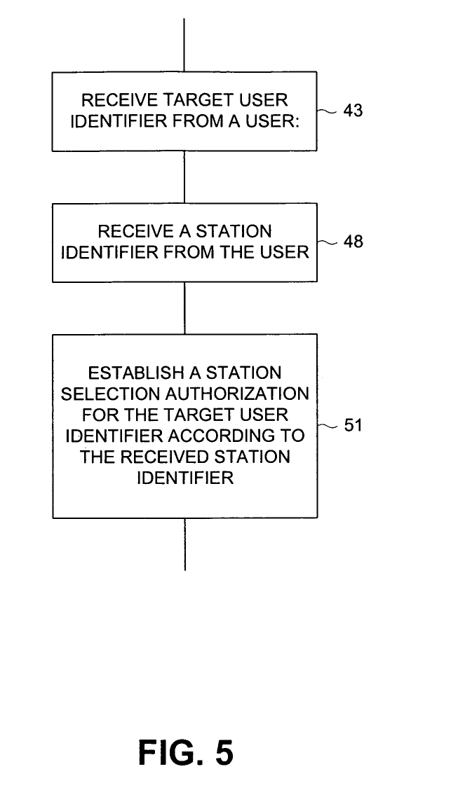

FIG. 5 is a flow diagram that depicts one illustrative method wherein a program authorization category is received in the form of a station identifier. In this variation of the present method, the program authorization category is received by receiving a target user identifier from a user (step 43). A station identifier is also received from the user (step 48). Once the station identifier is received from the user, a station selection authorization is established for the target user identifier according to the received station identifier (step 51). It should be appreciated that the user from which a particular program authorization category is received may need to be an authorized user has heretofore described.

FIG. 5A is a flow diagram that illustrates one example method wherein a program authorization category is received in the form of a maximum volume level for a particular user. It should be appreciated that come according to this variation of the present method, a program authorization category is received by first receiving a target user identifier from a user (step 330). A maximum volume level indicator is also received from the user (step 335). A maximum volume level for the target user identifier is then established according to the received maximum volume indicator. It should be appreciated that the user from which a particular program authorization category is received may need to be an authorized user has heretofore described.

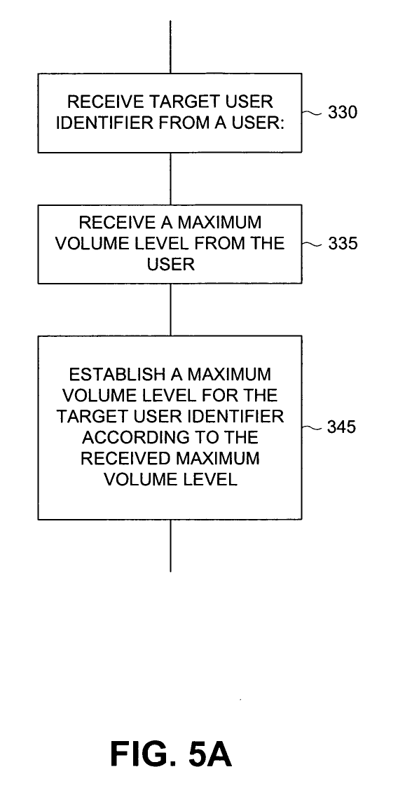

FIG. 6 is a flow diagram that depicts alternative example methods for receiving a category indicator for an audio track. It should be appreciated that an audio track is typically received by means of a broadcast channel. A broadcast channel, according to various alternative methods, includes at least one of an analog broadcast channel and a digital broadcast channel. Where an analog broadcast channel is used to receive an audio track, the analog broadcast channel may have an associated radio data system. According to one variation of the present method, the radio data system (step 70) is used to receive a category indicator for an audio track received by means of the analog broadcast channel. There are in fact many various forms of radio data systems, which heretofore have been used to receive station identification information and other miscellaneous information pertaining to a particular audio track (e.g. a song title). In yet another illustrative example, a category indicator for an audio track is received by means of a digitally modulated subcarrier (step 72), e.g. a subsidiary communications authority data channel.

In an alternative method, a category indicator is received for an audio track by means of a digital audio broadcast data channel while the audio track itself is received by means of analog modulated signal. For example, at least one digital broadcast standard provides a “hybrid mode” (e.g. iBiquity's in-band on-channel format i.e. IBOC, which is described in U.S. Pat. No. 5,588,022). In such a hybrid mode, the analog signal is still used to receive an audio track. However, digital data is carried by other data carriers within the same radio station channel. Where a digital broadcast channel is used to receive an audio track, the initial broadcast channel typically includes an ancillary data channel. In the case of an IBOC transmission, an audio track category indicator can be received from a system control channel or a program identification channel. In fact, any means of digital data conveyance from a broadcaster to a receiver can be used. Accordingly, another variation of the present method provides for receiving a category indicator for an audio track by means of a digital broadcast radio data channel (step 75).

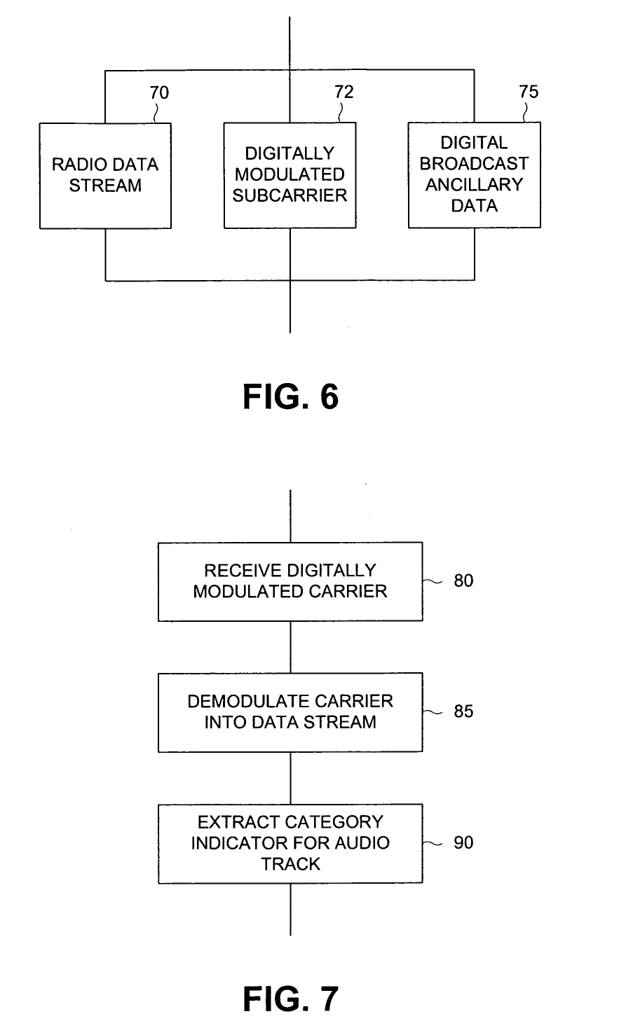

FIG. 7 is a flow diagram that depicts one example method for receiving a category indicator for an audio track. It should be appreciated that, irrespective of the type of broadcast channel used to receive an audio track, that an audio track category indicator is simply received by receiving a digitally modulated carrier (step 80). The carriers then demodulated into a datastream (step 85). A category indicator is then extracted from the datastream (step 90). It should likewise be appreciated that, according to various alternative methods, the digitally modulated carrier is modulated either in phase, amplitude or a combination of phase and amplitude. It should likewise be appreciated that, according to yet one alternative method, a plurality of digitally modulated carriers are used to convey a datastream, wherein the datastream is splintered into data sub-streams. Each data sub-stream is typically used to modulate one of the plurality of digitally modulated carriers. Upon reception, each digitally modulated carrier is demodulated into the constituent data sub-streams, which are then recombined to form a data sub stream from whence an audio track category indicator is obtained. This, for example, is a typical technique when orthogonally frequency division multiplexed (OFDM) carriers are employed to convey digital data within a particular spectral RF band For example IBOC digital broadcast radio employs OFDM carriers.

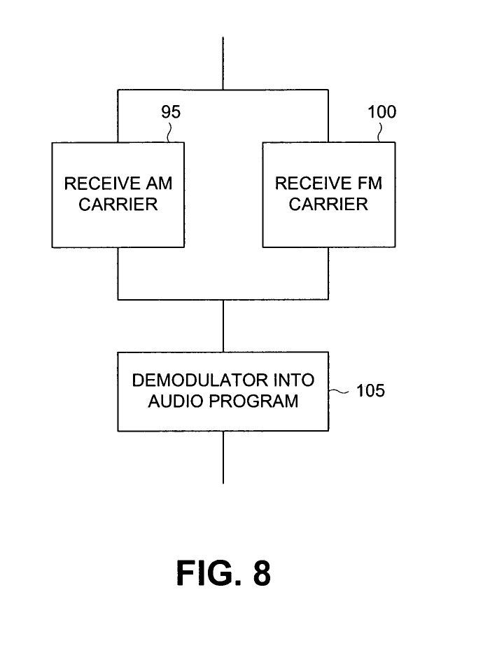

FIG. 8 is a flow diagram that depicts alternative example methods for receiving an analog rendition of an audio track. As heretofore described, an audio track, according to one variation of the present method, is received by receiving an amplitude modulated carrier (step 95). In an alternative variation of the present method, an audio track is received by receiving a frequency modulated carrier (step 100). Typically, the amplitude or frequency modulated carrier is modulated with an analog audio program. The received carrier is then demodulated into an audio program (step 105) using known techniques for demodulating either of an amplitude or frequency modulated carrier.

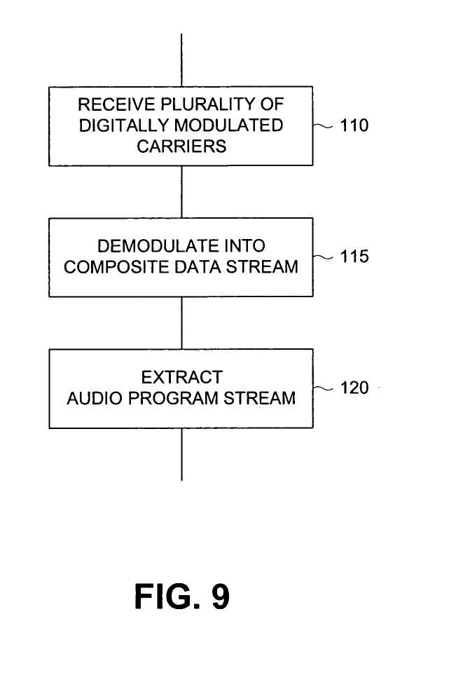

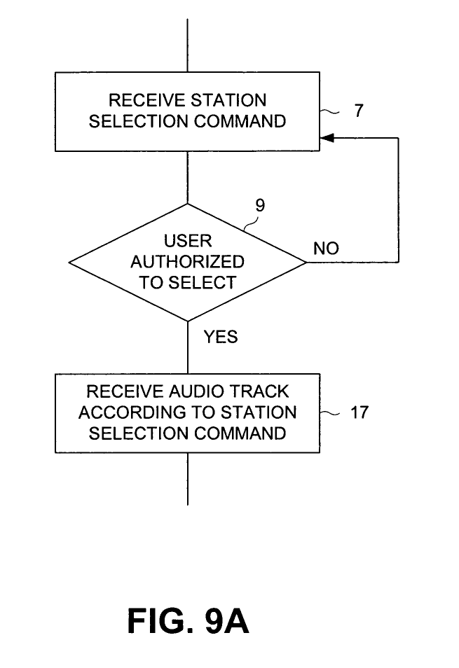

FIG. 9 is a flow diagram that depicts an alternative example method wherein an audio track is received as a digital datastream. According to this example method, an audio track is received by receiving a plurality of digitally modulated carriers (step 110). The individual digitally modulated carriers are then demodulated into constituent data sub-streams and combined to form a composite datastream (step 115). It should be appreciated that the composite datastream, according to one variation of the present method, comprises a time-multiplexed datastream that includes at least one out of an audio program and an ancillary data stream. Accordingly, an audio program is extracted from the composite datastream (step 120).

FIG. 9A is a flow diagram that depicts one example method for receiving an audio track according to user station authorizations. In this variation of the present method, a station selection command is received (step 7). Once the station selection command is received, is compared against an enumeration of stations that a particular user is authorized to receive (step 9). When the particular user that has issued the station selection command is authorized to receive the selected station, an audio track is received according to the station selection command (step 17). It should be appreciated that, according to one variation of the present method, an audio program is selected according to a station selection by actually selecting a different radio station (e.g. by tuning a receiver). In yet another variation of the present method, an audio program is selected according to a station selection by selecting a program stream included in a digital datastream received from a digital broadcast radio station (e.g. an IBOC radio station). It should further be appreciated that, according to one variation of the present method, an audio track is only presented to a user when the audio track category indicator associated with a currently received audio track is substantially equivalent to the program authorization category for that user.

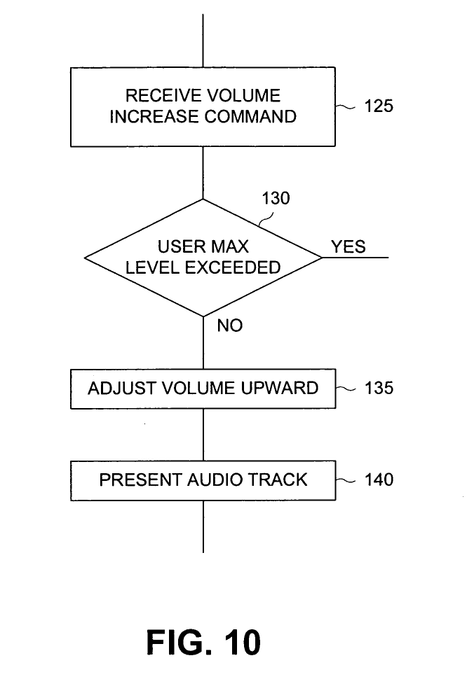

FIG. 10 is a flow diagram that depicts one example method for presenting an audio track according to a particular user's maximum volume authorization. According to this variation of the present method, presentation of an audio track is accomplished by receiving a volume increase command (step 125) and then determining whether or not increasing presentation volume according to the volume increased command would exceed a particular user's maximum volume authorization (step 130). So long as a particular user's maximum volume authorization is not exceeded, the volume level for audio presentation is increased (step 135). An audio track is then presented according to the increased volume level adjusted according to the volume increase command (step 140).

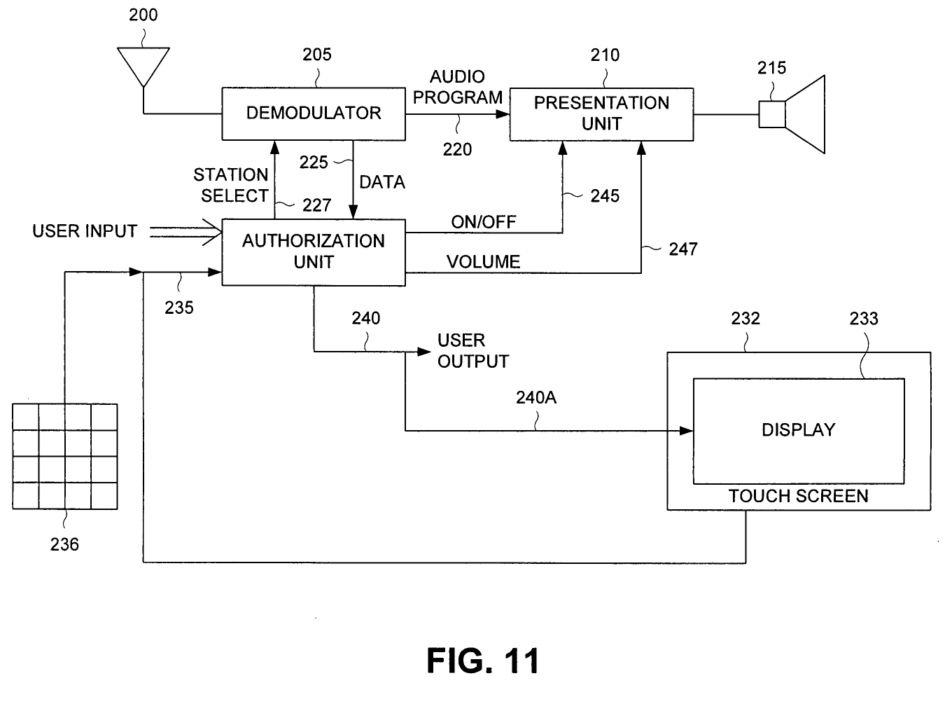

FIG. 11 is a block diagram that depicts several example embodiments of an audio presentation system. In one example embodiment, an audio presentation system comprises a demodulator 205, an authorization unit 230 and a presentation unit 210. In operation, the demodulator 205 receives a modulated signal (typically by means of an antenna 200). The modulated signal includes an audio program and an audio track category indicator. The authorization unit 230 receives the audio track category indicator 225 and also receives user input 235. The authorization unit generates an enable signal 245 according to the ancillary data 225 and according to the user input 235. The presentation unit 210 receives an audio program 220 from the demodulator 205. The presentation unit 210 directs an audio signal to a speaker 215 when the enable signal 245 is active so as to enable presentation of an audio program to a user. It should be appreciated that, according to one alternative example embodiment, the presentation unit 210 also receives a volume setting 247 from the authorization unit 230. In this alternative example embodiment, the presentation unit 210 adjusts the level of the audio signal provided to the speaker 215 according to the volume setting 247 received from the authorization unit 230. It should likewise be appreciated that the authorization unit, according to one alternative example embodiment, simply reduces the volume setting 247 when it needs to disable presentation of an audio track to a user by the presentation unit 210.

FIG. 11 further illustrates that, according to one alternative illustrative embodiment, an audio presentation system further comprises a user interface device. In one example embodiment, the user interface device comprises a keyboard 236. In this embodiment, the user interface receives an input in the form of a user keystroke from the keyboard 236. Such keystrokes may represent alphanumeric characters and/or special user commands. In yet another alternative example embodiment, the user interface comprises a display 233 and an associated touch screen 232. In this case, user output 240 is directed to the display 233 and user input is received by the user interface in the form of touch events 237. In this manner, a graphical user interface is established between the authorization unit 230 and a user. It should be appreciated that the management of a graphical user interface is well known and will not be discussed further.

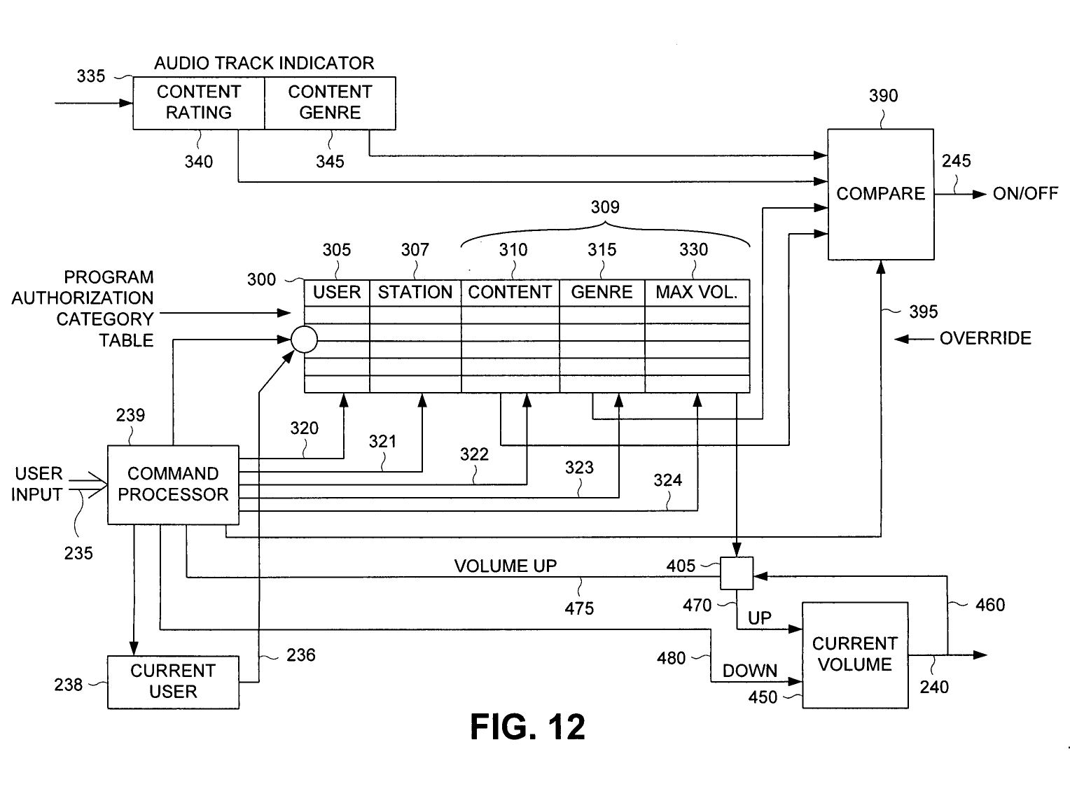

FIG. 12 is a pictorial illustration that depicts the internal structure of various alternative embodiments of an authorization unit. Once the authorization unit 230 begins operating, it receives user input 235 for the purposes of initializing a program authorization category table 300. The user input is processed by a command processor 239, also included in one example alternative embodiment of an authorization unit 230. The program authorization category table 300 is maintained in a memory included in the authorization unit 230. The first user input received by the authorization unit 230 includes a current user identifier. The current user identifier is stored in a current user register 238. In order to allow a current user to establish a program authorization category in the program authorization category table 300, a current user must be authorized with such privilege. As such, one alternative example embodiment of an authorization unit 230 includes a controller that accepts additional user input in the form of a password. In this example embodiment, the password is validated before a program authorization category is received. In yet another alternative example embodiment, the command processor 239 recognizes a particular user identifier as having implicit authorization rights and does not require a user to enter a password. In either case, a current user associated with the identifier is stored in the current user register 238 is thus authorized to establish a program authorization category in the program authorization category table 300.

In one example embodiment, the program authorization category table 300 is used to store one or more records wherein each record includes a user identifier field 305 and a program authorization category 309. Accordingly, a program authorization category is associated with a particular user by means of a target user identifier stored in the user field 305 of a particular record stored in the program authorization category table 300. In one alternative example embodiment, a record stored in the program authorization category table 300 includes a content rating field 310. In this case, the command processor 239 recognizes user input 235 in the form of a maximum content rating for a particular user, which is stored 322 into the content rating field 310 along with a user identifier 320. It should be appreciated that the target user identifier is stored in a user identifier field 305 in the same record used to store the program authorization category. In yet another alternative example embodiment, user input 235 is recognized by the command processor 239 as a genre enablement for a particular target user and stores 323 the genre enablement into the genre enablement field 315 along with a particular target user identifier 320, which is stored in the user identifier field 305 of the same record. It should be appreciated that the command processor 239 typically recognizes an authorization command that includes a target user identifier which identifies a particular user for which an authorization entry is to be made in the program authorization category table 300.

In one example embodiment, the program authorization category table 300 is used to store one or more records wherein each record includes a user identifier field 305 and a station identifier 307. Accordingly, a program authorization category in the form of an authorized content source is associated with a particular user by means of a target user identifier stored in the user field 305 of a particular record stored in the program authorization category table 300. It should also be appreciated that, according to one illustrative alternative embodiment, a station identifier comprises a radio station identifier. In yet another alternative example embodiment, a station identifier comprises not only a radio station identifier, but further includes a digital datastream identifier. A digital datastream identifier is used to identify a particular program stream broadcast by a digital broadcast radio station (e.g. an IBOC digital audio broadcast radio station). It should be appreciated that the command processor 239 typically recognizes an authorization command that includes a target user identifier which identifies a particular user for which an authorization entry is to be made in the program authorization category table 300.

FIG. 12 further illustrates that, according to one alternative example embodiment, a record included in a program authorization category table 300 also includes a maximum volume indicator field 330. In this example embodiment, the maximum volume indicator field 330 is used to store a maximum volume that a particular target user is authorized to apply to the presentation unit 210. Accordingly, in this alternative example embodiment of the command processor 239 receives user input 235 in the form of a maximum volume level indicator and a target user identifier. The maximum volume level indicator and target user identifier received by the command processor 239 within stored in the program authorization category table 300 and a particular record. Typically, the maximum volume level indicator is stored in the maximum volume indicator field 330 and a target user identifier is stored in the user field 305 of the same record stored in the program authorization table 300.

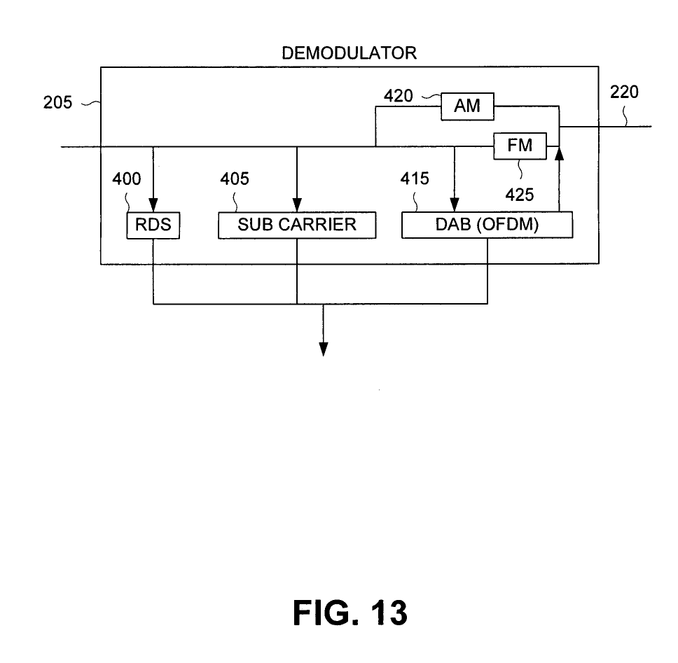

FIG. 13 is a block diagram that illustrates alternative example embodiments of a demodulator. According to one alternative example embodiment, the demodulator 205 includes a radio data system (RDS) demodulator 400. In yet another alternative example embodiment, the demodulator 205 includes a subcarrier demodulator 405. In yet another alternative example embodiment, the demodulator 205 includes a digital audio broadcast demodulator 415. It should be appreciated that yet another alternative embodiment provides that the digital audio broadcast demodulator 415 includes an orthogonal frequency division multiplex (OFDM) demodulator. In each of these alternative example embodiments, at least one of a radio data system demodulator 400, a subcarrier demodulator 405 and a digital audio broadcast demodulator 415 extracts and audio track category indicator 225 from a modulated signal received by the demodulator 205. The idea track category indicator 225 is provided to the authorization unit 230. It should likewise be appreciated that the authorization unit 335 includes an audio track indicator register 335, which is used to store an audio track category indicator 225 received from the demodulator 205.

FIG. 13 further illustrates that, according to one alternative example embodiment, the demodulator 205 further includes an amplitude modulated analog program receiver 420. In this alternative example embodiment, the amplitude modulated program receiver 420 decodes a modulated signal received by the demodulator 205 into an audio program 220, which is then directed to the presentation unit 210. In yet another alternative example embodiment, the demodulator 205 includes a frequency modulated program receiver 425. This alternative embodiment, the frequency modulated program receiver 425 decodes a modulated signal received by the demodulator 205 into an audio program 220, which is then directed to the presentation unit 210. In yet another alternative example embodiment, the demodulator 205 includes a digital audio broadcast receiver 415. In this alternative embodiment, the digital broadcast receiver 415 receives a plurality of digitally modulated carriers and extracts a program stream from the plurality digitally modulated carriers. Techniques for receiving digital audio broadcast, such as those described in U.S. Pat. No. 5,588,022, are well-known and will not be described herein. It should be appreciated that a wide variety of digital audio broadcast means are currently known and the scope of the claims appended hereto is not intended to be limited to any particular example set forth herein.

FIG. 12 also illustrates one alternative example embodiment wherein an authorization unit 230 also includes a comparator 390. In this alternative embodiment, the comparator 390 compares a program authorization category stored in the program authorization category table 300 to an audio track category indicator stored in the audio track category indicator register 335. To be appreciated that a program authorization category is retrieved from the program authorization category table 300 according to a current user identifier 236 stored in the current user register 238. The comparator 390 generates an enable signal 245 according to this comparison. Accordingly, when the idea track category indicator stored in the idea track category indicator register 335 is commensurate with the program authorization category received from the program authorization category table 300, an enable signal 245 is generated. The enable signal 245 enables the presentation unit 210 to present an audio program 220 to a user.

In yet another alternative example embodiment, the authorization unit 230 includes a current volume of register 450. The current volume register 450 is used to store a volume indicator; this is directed 247 to the presentation unit 210. In this alternative example embodiment, the command processor 239 receives user input 235 in the form of a volume increase command. The command processor 239 can also receive user input 235 in the form of a volume decrease command. In response to receiving a volume decrease command, the command processor 239 decrements 480 the value stored in the current volume register 450. However, in response to receiving a volume increase command, the command processor 239 increments 475 the value stored in the current volume register 450, but only when such increase will not exceed a maximum volume level for a current user. In this embodiment, a current-user identifier 236, which is stored in the current user register 238, is used to select a record in the program authorization category table 300. In maximum volume level is retrieved from a maximum volume field 330 from selected record. This is directed to a volume comparator 465, which passes 470 the increment command from the command processor 239 so long as the value 460 stored in the current volume register 450 is less than a maximum volume level retrieved from the program authorization category table 300.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

One such modification includes various combinations of program authorization categories better stored in the program authorization category table 300. According to one illustrative embodiment, a target user identifier is stored in a user field 305 along with a station (or content source) identifier 307. However, according to one alternative illustrative embodiment, the station identifier is also stored along with a maximum content program category, which is stored in the content field 310 of the same record. In this manner, different maximum content ratings for different content sources can be specified for a particular target user. Likewise, different maximum volume levels can be specified for different genera or different content sources. Again, all of these various alternatives are intended to be included the scope of the claims appended hereto.

What is claimed is:

1. A method for receiving an audio program comprising:
receiving a program authorization category;
receiving a category indicator for an audio track;
receiving an audio track;
determining if the audio track category indicator is substantially equivalent to the program authorization category; and
presenting the audio track to a user when the audio track category indicator is substantially equivalent to the program authorization category.

2. The method of claim 1 wherein receiving a program authorization category comprises:
receiving a user key stroke or a touch-screen event from a user; and
determining a program authorization category according to the key stroke or the touch-screen event.

3. The method of claim 1 wherein receiving a program authorization category comprises:
receiving a user identifier;
receiving a program authorization category from the user; and
establishing a program authorization category when the user identifier is associated with a user authorized to establish a program authorization category either by password or implicit by the user identifier.

4. The method of claim 1 wherein receiving a program authorization category comprises:
receiving a target user identifier from a user;
receiving a program authorization category from the user; and
establishing a program authorization category for the target user identifier according to the received program authorization category.

5. The method of claim 1 wherein receiving a program authorization category comprises:
receiving a target user identifier from a user;
receiving a station identifier from the user; and
establishing a station selection authorization for the target user identifier according to the received station identifier.

6. The method of claim 1 wherein receiving a program authorization category comprises:
receiving a target user identifier from a user;
receiving a maximum volume level from the user; and
establishing a maximum volume level for the target user identifier according to the received maximum volume level.

7. The method of claim 1 wherein receiving a category indicator for an audio track comprises receiving a category indicator for an audio track by means of at least one of a radio data system channel, a digitally modulated subcarrier and a digital broadcast radio data channel.

8. The method of claim 1 wherein receiving a category indicator for an audio track comprises:
receiving a digitally modulated carrier;
demodulating the digitally modulated carrier in order to recover a data stream; and
extracting a category indicator for an audio track from the data stream.

9. The method of claim 1 wherein receiving an audio track comprises:
receiving a carrier that is modulated in at least one of an amplitude modulated manner and a frequency modulated manner; and
demodulating the carrier in order to recover an analog program.

10. The method of claim 1 wherein receiving an audio track comprises:
receiving a plurality of digitally modulated carriers; and
demodulating the digitally modulated carriers in order to recover a data stream; and
extracting an audio program from the data stream.

11. The method of claim 1 wherein receiving an audio track comprises:
receiving a station selection command;
receiving an audio track according to the station selection command when a current user is authorized to receive a station identified in the station selection command.

12. The method of claim 1 wherein presenting the audio program comprises:
receiving a volume increase command;
increasing a presentation volume level when such increase would not exceed a maximum volume level for a current user;
presenting the audio track to a user according to the presentation volume level.

13. An audio presentation system comprising:
demodulator capable of receiving a modulated signal that includes an audio program and an audio track category indicator;
authorization unit that generates an enable signal according to the audio track category indicator and also according to a user input; and
presentation unit capable of presenting the audio program to a user according to the enable signal.

14. The audio presentation system of claim 13 wherein the authorization unit further includes a user interface capable of receiving a user input in the form of a user keystroke or in the form of a touch-screen event.

15. The audio presentation system of claim 13 wherein the authorization unit further includes a user interface capable of receiving a user input in the form of a user identifier and further includes a controller that determines if the user identifier corresponds to an authorized user either be receiving a password from the user interface or by comparing the user identifier to a pre-established value.

16. The audio presentation system of claim 13 wherein the authorization unit further includes a user interface capable of receiving a user input in the form of program authorization category and a target user identifier and wherein the authorization unit includes a memory for storing the program authorization category in association with the target user identifier.

17. The audio presentation system of claim 13 wherein the authorization unit further includes a user interface capable of receiving a user input in the form of a content source identifier and a target user identifier and wherein the authorization unit includes a memory for storing the content source identifier in association with the target user identifier.

18. The audio presentation system of claim 13 wherein the authorization unit further includes a user interface capable of receiving a user input in the form of a maximum volume level indicator and a target user identifier and wherein the authorization unit includes a memory for storing the maximum volume level indicator in association with the target user identifier.

19. The audio presentation system of claim 13 wherein the demodulator includes at least one of a radio data system data receiver, a digitally modulates subcarrier receiver and a digital broadcast data receiver.

20. The audio presentation system of claim 13 wherein the demodulator extracts a category indicator for an audio track from a digitally modulated signal.

21. The audio presentation system of claim 13 wherein the demodulator comprises at least one of an amplitude modulated analog program receiver and a frequency modulated analog program receiver.

22. The audio presentation system of claim 13 wherein the demodulator comprises a multi-carrier demodulator capable of receiving a plurality of digitally modulated carriers and a program extractor capable of generating an audio data stream from the plurality of digitally modulated carriers.

23. The audio presentation system of claim 13 wherein the authorization unit includes a memory for storing in association with a current user identifier one or more identifiers for content sources and is further capable of receiving a station selection command and generating a station selection signal for the demodulator according to the station selection command when the station selection command includes a content source identifier stored in the memory in association with a current user.

24. The audio presentation system of claim 13 wherein the authorization unit includes a memory for storing in association with a current user identifier a maximum volume level indicator and also includes a volume level register and wherein the audio presentation unit presents an audio track at a volume level specified by the contents of the volume level register and wherein the authorization unit is further capable of receiving a volume increase command and increases a value stored in the volume level register when such increase does not exceed a maximum volume level indicator stored in the memory in association with a current user.
